(19) United States
(12) Patent Application Publication
(10) Pub. No.: US 2015/0206154 A1
(43) Pub. Date: Jul. 23, 2015

(54) METHODS AND SYSTEM FOR DETERMINING USER ATTRIBUTES

(71) Applicant: Wipro Limited, Bangalore (IN)

(72) Inventors: Anil Kumar Lenka, Bangalore (IN); Raghavendra Hosabettu, Bangalore (IN); Raja Sekhar Reddy Sudidhala, Bangalore (IN); Kiran Kumar Channarayapatna Sathyanarayana, Bangalore (IN)

(73) Assignee: Wipro Limited, Bangalore (IN)

(21) Appl. No.: 14/198,190

(22) Filed: Mar. 5, 2014

(30) Foreign Application Priority Data
Jan. 18, 2014 (IN) 213/CHE/2014

(51) Int. Cl. G06Q 30/02; G06F 3/041

(52) U.S. Cl. CPC G06Q 30/0201; G06F 3/041

(57) ABSTRACT

This disclosure relates to methods and systems for determining user attributes. In one embodiment, a method performed by an electronic device for determining user attributes receiving a touch input is disclosed, the method comprising: determining one or more sets of touch parameters based on the touch input, each set associated with a user attribute; identifying, for each of the one or more sets of touch parameters, an associated set of stored touch parameters from among a plurality of stored touch parameters based on a predefined criterion of match between the set of touch parameters and the plurality of stored touch parameters; determining, for each of the one or more sets of touch parameters, the associated user attribute based on the associated set of stored touch parameters; and providing the determined user attribute associated with each of the one or more sets of touch parameters.

This application claims the benefit of Indian Patent Application No. 213/CHE/2014 filed Jan. 18, 2014, which is hereby incorporated by reference in its entirety.

### FIELD

This disclosure relates generally to user interaction with touch based interfaces, and more particularly to methods and systems for determining user attributes.

### BACKGROUND

Media agencies target at providing relevant media such as programs or advertisements to audience by gathering audience data. The audience data may be manually collected by the media agencies by conducting surveys or providing a questionnaire to viewers about their demographic information or personal information. The media agencies then analyze the response of the viewers to provide relevant media accordingly.

Given the proliferation of touch screen devices to view media content, it is desirable that there is a mechanism to determine various attributes associated with the audience by using the touch screen devices instead of manually conducting surveys or providing questionnaires.

### SUMMARY

In one embodiment, a method performed by an electronic device for determining user attributes receiving a touch input is disclosed, the method comprising: determining one or more sets of touch parameters based on the touch input, each set associated with a user attribute; identifying, for each of the one or more sets of touch parameters, an associated set of stored touch parameters from among a plurality of stored touch parameters based on a predefined criterion of match between the set of touch parameters and the plurality of stored touch parameters; determining, for each of the one or more sets of touch parameters, the associated user attribute based on the associated set of stored touch parameters; and providing the determined user attribute associated with each of the one or more sets of touch parameters.

In one embodiment, an electronic device is disclosed, the electronic device comprising: at least one hardware processor; and a memory storing instructions executable by the at least one processor, wherein the instructions configure the at least one processor to: receive a touch input; determine one or more sets of touch parameters based on the touch input, each set associated with a user attribute; identify, for each of the one or more sets of touch parameters, an associated set of stored touch parameters from among a plurality of stored touch parameters based on a predefined criterion of match; determine, for each of the one or more sets of touch parameters, the associated user attribute based on the associated set of stored touch parameters; and provide the determined user attribute associated with each of the one or more sets of touch parameters.

In one embodiment, a non-transitory computer readable medium is disclosed, the non-transitory computer readable medium storing instructions that, when executed by at least one hardware processor, cause the at least one hardware processor to perform operations comprising: receiving a touch input; determining one or more sets of touch parameters based on the touch input, each set associated with a user attribute; identifying, for each of the one or more sets of touch parameters, an associated set of stored touch parameters from among a plurality of stored touch parameters based on a predefined criterion of match between the set of touch parameters and the plurality of stored touch parameters; determining, for each of the one or more sets of touch parameters, the associated user attribute based on the associated set of stored touch parameters; and providing the determined user attribute associated with each of the one or more sets of touch parameters.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1A illustrates a flowchart for determining user attributes in accordance with some embodiments.

FIG. 1B illustrates a flowchart for determining a user attribute based on a set of stored parameters in accordance with some embodiments.

FIG. 2 illustrates an electronic device for determining user attributes in accordance with some embodiments.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

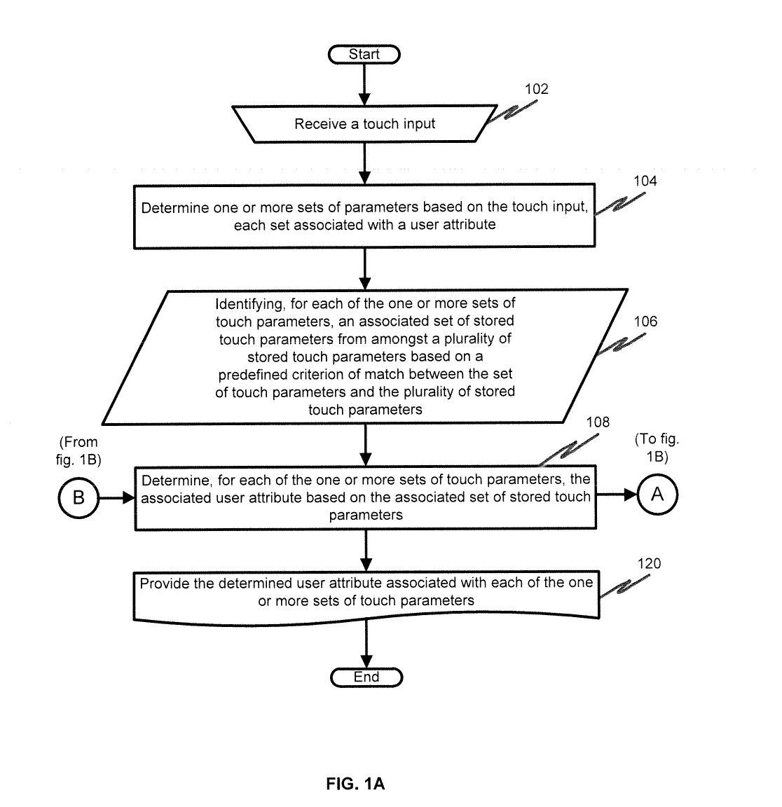

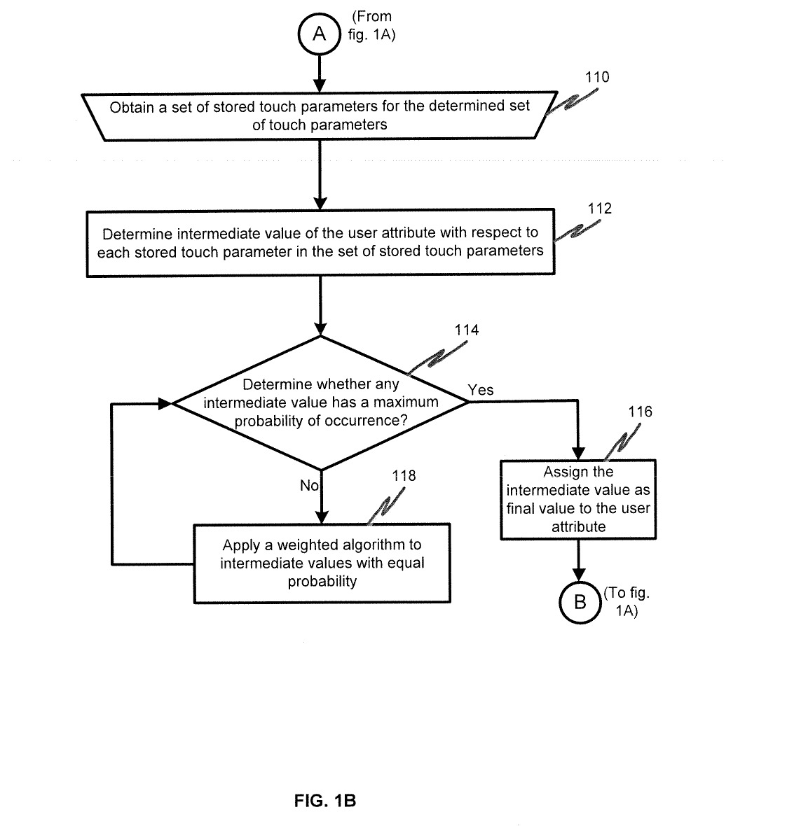

FIG. 1 illustrates a flowchart for determining user attributes in accordance with some embodiments. In step 102, an electronic device may receive a touch input from a user. In some embodiments, the electronic device may include a touch screen device such as a touch screen mobile device, a touch pad, a tablet, a touch screen laptop, or any other electronic device having processing and touch screen capabilities. Further, the touch input may include a touch stroke from a user. The touch stroke may include swiping a touch screen or a touch pad of the electronic device. The swipe input may include a horizontal, vertical, or a diagonal drag on the touch screen. It should be apparent to a person skilled in the art, however, that the touch input is not limited to the mentioned touch input and may also include multiple swipe inputs on the touch screen (e.g. pinch-to-zoom), swipe input in a predetermined direction around a 360° angle from a starting point, and swipe inputs in a continued sequence of directions such as a pattern.

In step 104, a processor of the electronic device may determine one or more sets of touch parameters based on the touch input, each set of touch parameters associated with a user attribute. Examples of user attributes may include, but not limited to, an age group associated with a user, a gender associated with the user, an emotion associated with the user, an ethnicity associated with the user, and a personality characteristic associated with the user.

Once the electronic device receives the touch input, the processor of the electronic device may determine a plurality of touch parameters based on the touch input. These determined touch parameters may include a length of a touch stroke associated with the touch input. For example, the length of a swipe stroke on a touch screen of the electronic device may be 500 pixels. The touch parameters may further include a number of touch segments and length of each segment associated with the swipe stroke. Here, a touch segment is defined as a continuous portion of the length of the swipe stroke across which one or more of pressure, speed, an area of contact, and linearity are uniform across that entire portion. In other words, a touch segment is a continuous portion of the touch stroke until a substantial change in pressure or length, area of contact, or linearity is experienced. In keeping with the previous example, the swipe stroke of 500 pixels length may include 4 touch segments, of length 110 pixels, 125 pixels, 100 pixels, and 165 pixels. Here the length of the entire touch stroke may be divided into different touch segments because a different but uniform pressure is applied across each touch segment. Additionally, the touch segment having length 110 pixels may have experienced a uniform speed that is substantially different from the speed experienced by the touch segment having length 125 pixels. A possible reason for this may be that the touch segment having length 125 pixels may be drawn in a different direction than, but in continuity with, the touch segment having length 110 pixels. This may occur when a touch stroke includes a continuous pattern in a sequence of multiple directions.

Further, the touch parameters may also include a maximum length of any touch segment and a minimum length of any touch segment among length of all touch segments. Further, the touch parameters may include an average length of the touch segments, which may be determined based on mean average of length of all the touch segments. The touch parameters may further include a pressure applied across each touch segment and an average pressure applied across all the touch segments associated with a touch input. The average pressure may be determined by calculating a weighted mean of pressure applied across all the touch segments. For example, if the pressure across three touch segments is 10, 12, and 14 units respectively, the average pressure across these touch segments may be determined to be 12 units if the segments are of same length. However, if the segments are of varying length, the weighted mean may be calculated by considering length of a segment as its weight. Further, the touch parameters may include a maximum pressure applied on any touch segment and a minimum pressure applied on any touch segment among all the touch segments.

Additionally, the touch parameters may include a force per unit length of a touch segment on which the maximum pressure is applied. This may include a product of the pressure applied on that segment and the length of that segment. Similarly, the touch parameters may also include a minimum force per unit length of the touch segment on which minimum pressure is applied. Further, the parameters may include an average force per unit length which is a product of average pressure across all touch segments and an average length of the touch segments. Further, the touch parameters may also include area of each touch segment, a maximum area of any touch segment, and a minimum area of any touch segment among the area of all the touch segments, an average area of all the touch segments, and a total area covered by the touch stroke on the touch screen of the electronic device. The touch parameters may further include a total duration of contact of a touch stroke with the touch screen and duration of contact of the touch stroke across each segment. For example, the processor may determine that a user contacts the touch screen for 400 milliseconds in case of a swipe stroke and the duration of contact for 3 different touch segments associated with this touch stroke is 150, 50, and 200 milliseconds respectively. The touch parameters may further include a speed associated with each of the touch segments and a speed across the entire touch stroke (which is computed by dividing the total length of the touch stroke by the total duration of contact). The parameters may further include an average speed associated with all the touch segments. This may be computed by a mathematical formula: average of length of all touch segments/(total duration of contacts*number of touch segments)

The touch parameters may further include a direction of the touch stroke and a degree of curve or linearity associated with the touch stroke. A touch stroke may be a straight line, a curve, a touch pattern in a sequence of directions such as an open-ended or a closed polygon that may be uniform or non-uniform/random. In one example, a touch stroke may be applied towards right direction along the horizontal axis, the shape of the touch stroke may be a straight line that is 90% linear i.e., the straight line has 90% uniformity with respect to an ideal straight line.

On determining the discussed touch parameters based on the touch input, the processor may group the touch parameters into one or more sets of touch parameters according to a grouping table 1 that is stored in a memory of the electronic device. The stored grouping table 1 may include a mapping between names of sets of touch parameters and names of their associated user attributes. In some embodiments, at the time of manufacturing the electronic device, a manufacturer may have associated a set of touch parameters with each user attribute by mapping the names of touch parameters in a set with a name of the user attribute. Here, the association between a set of touch parameters and its associated user attribute indicates that the touch parameters included in that set are required to be determined in order to determine a value of the user attribute associated with that set, at a later stage. For example, to determine a value of a user attribute ‘gender’ (e.g. male or female), the touch parameters indicated in the column ‘gender’ in the grouping table 1, need to be determined. For exemplary purposes, grouping table 1 is illustrated below:

GROUPING TABLE 1
Mapping between set of touch parameters and user attributes

| | User attribute | | |
|---|---|---|---|
| | Age group | Gender | Emotion |
| Set of Touch | Average pressure | Average pressure | Average force per |
| parameters | associated with | associated with | unit length across |
| | the touch stroke | the touch stroke | all touch |
| | | | segments |
| | Maximum | Maximum | Maximum force |
| | pressure across | pressure across | per unit length |
| | any touch | any touch | across any touch |
| | segment | segment | segment |
| | Minimum | Minimum | Minimum force |
| | pressure across | pressure across | per unit length |
| | any touch | any touch | across any touch |
| | segment | segment | segment |
| | Speed associated | Speed associated | Average pressure |
| | with the touch | with the touch | associated with |
| | stroke | stroke | the touch stroke |
| | Average speed | Average speed | Maximum |
| | associated with | associated with | pressure across |
| | the touch | the touch | any touch |
| | segments | segments | segment |
| | Total length of | Total area | Minimum |
| | touch stroke | covered by touch | pressure across |
| | | stroke | any touch |
| | | | segment |
| | Average length of | Maximum area | Speed associated |
| | touch segments | of any touch | with the touch |
| | | segment | stroke |
| | Maximum length | Minimum area | Average speed |
| | of any touch | of any touch | associated with |
| | segment | segment | the touch |
| | | | segments |
| | Minimum length | Total length of | Total area |
| | of any touch | touch stroke | covered by touch |
| | segment | | stroke |
| | Direction of | Average length | Maximum area of |
| | touch stroke | of touch | any segment |
| | | segments | |
| | Total area | Maximum length | Minimum area of |
| | covered by touch | of any touch | any segment |
| | stroke | segment | |
| | Maximum area of | Minimum length | Total length of |
| | any touch | of any touch | touch stroke |
| | segment | segment | |
| | Minimum area of | Direction of | Average length of |
| | any touch | touch stroke | touch segments |
| | segment | | |
| | | | Maximum length |
| | | | of any touch |
| | | | segment |
| | | | Minimum length |
| | | | of any touch |
| | | | segment |
| | | | Direction of touch |
| | | | stroke |

As illustrated in grouping table 1, a user attribute may be associated with a set of touch parameters. The processor may group the determined plurality of touch parameters into one or more sets according to grouping table 1. For exemplary purposes, the processor may create 3 sets of touch parameters corresponding to the names of user attributes—age group, gender, and emotion. It should be understood, however, that the number of sets of touch parameters are not limited to this and may include more or less number of sets corresponding to additional user attributes. Further, additional sets corresponding to other user attributes such as ethnicity and personality characteristics associated with a user may also be created. Multiple touch parameters may be included in these sets in a similar manner as that of the user attributes age group, gender, and emotion.

In each set of touch parameters associated with a user attribute, the processor may then populate the values of the touch parameters that are determined based on the touch input from the user. The processor may do so for each set by populating the values of touch parameters corresponding to that set as indicated in grouping table 1. For example, in a set of touch parameters that is created corresponding to user attribute ‘age group’, the processor may include values of all touch parameters mentioned under the name “age group” in group table 1. On populating these values, the set of touch parameters corresponding to the user attribute ‘age group’ may indicate that the total length of a touch stroke is 300 pixels, maximum length of a touch segment is 90 pixels, minimum length of a touch segment is 65 pixels, maximum area of a touch segment is 370 square pixels, maximum pressure associated with a pixel is 90 units and so on for all the touch parameters in the set associated with the user attribute ‘age group.’ Similarly, other sets of touch parameters associated with user attributes ‘gender’ and ‘emotion’ may also be populated with the values of their respective touch parameters indicated in grouping table 1. Consequently, the processor may form 3 sets of touch parameters corresponding to each of the user attribute: age group, gender, and emotion, each including values of their respective touch parameters that are determined based on the touch input. It should be apparent to a person skilled in the art, however, that if there are other user attributes such as ethnicity and/or personality characteristics, the processor creates additional sets of touch parameters for each of these user attributes.

In step 106, the processor may identify, for each of the one or more sets of touch parameters, an associated set of stored touch parameters from among a plurality of stored touch parameters. The identification may be performed based on a predefined criterion of match between the set of touch parameters and the plurality of stored touch parameters.

In some embodiments, the memory of the electronic device may include the plurality of stored touch parameters in the form of training data sets associated with each user attribute. In some embodiments, these training data sets may have been stored in the memory by a manufacturer at the time of manufacturing the electronic device. In some embodiments, however, these training data sets may be downloadable as a software update by a user of the electronic device. The update may have been provided by a software administrator. The memory of the electronic device may include a training data set associated with each user attribute. A training data set associated with a user attribute may include multiple values for each touch parameter associated with the user attribute. Further, the training data set may include these values of touch parameters for each of the possible value that the user attribute takes.

In one example, a user attribute ‘gender’ may have 2 possible values—‘male’ and ‘female’ as defined by the manufacturer or an administrator who provides these values as a software update. In this scenario, the training data set for the user attribute ‘gender’ may include a large number of touch parameter values from both male users as well as female users. These sample values may have been determined previously based on touch inputs from a large number of male users. In this example, the training data set may include 80 sample values of length associated with the touch stroke measured from 80 different male users. Likewise, this ‘gender’ training data set may also include 80 sample values for each of the total area covered by the touch stroke associated with the touch stroke, minimum length of any touch segment, maximum length of any touch segment, and so on for all the touch parameters included under the column ‘gender’ in grouping table 1. Similarly, the training data set may also include 80 sample values for each of the touch parameters indicated in the column ‘gender’, that are determined from 80 different female users.

In some embodiments, the male and female values for a touch parameter that are included in the training data set may be represented by using various machine learning algorithms such as support vector machine (SVM) learning, a k-nearest neighbor (k-NN) algorithm, logistic regression etc. which are known in the art to classify values of multiple categories (e.g., male and female, in this case). In an exemplary scenario, SVM may be used to classify various categories (or values of a user attribute) in a training data set. Here, for a touch parameter such as length of touch stroke, 80 values, for example, of length of touch stroke determined from both male users as well as female users may be stored in the memory. These values may first be classified as male sample values or female sample values according SVM and then stored against each touch parameter. The processor may store sample values in a similar way for all other touch parameters associated with the user attribute ‘gender’ and thus, create a training data set associated with the user attribute ‘gender.’

The processor may further create training data sets that are associated with all other user attributes such as ‘age group’, ‘emotion’, ‘ethnicity’, and/or ‘personality characteristics.’ These user attributes may also take multiple values like ‘gender.’ For example, the user attribute ‘age group’ may have 5 different values: below 10 years, 10-20 years, 20-35 years, 35-50 years, and above 50 years. The limits of age groups may be randomly defined by the manufacturer of the electronic device or an administrator, in some embodiments. Similarly, the user attribute ‘emotion’ may have 8 possible values of ‘emotion’: ‘anger’, ‘fear’, ‘sadness’, ‘disgust’, ‘surprise’, ‘anticipation’, ‘trust’, and ‘joy.’ Here, a touch input from a user exhibiting a ‘joy’ emotion may result in different sample values for a particular touch parameter than a touch input from a user exhibiting fear. For example, a touch stroke from a user exhibiting ‘fear’ may have more speed as compared to a touch stroke from user exhibiting the ‘joy’ emotion.

It should be apparent to a person skilled in the art that the user attribute ‘ethnicity’ may have various possible values such as African, Mongolian, Asian, American etc. Further, the user attribute ‘personality characteristics’ may also have multiple values such as introvert, extrovert, shy, cheerful etc. Further, the number of values for each user attribute may be more or less than the specified numbers depending upon the number of values defined by the manufacture or the administrator and is not necessarily limited.

Once the processor has determined a set of touch parameters associated with a user attribute based on the touch input from a user, the processor may then identify, for the determined set of touch parameters, an associated set of stored touch parameters from the training data sets associated with that user attribute. In one example, the processor may determine a set of touch parameters corresponding to each of the user attributes—‘age group’, ‘gender’, ‘emotion’, ‘ethnicity’, and/or ‘personality characteristic’ based on the touch input. The processor may then identify a set of stored touch parameters for each of the determined sets of touch parameters. In one example, for the determined set of touch parameters associated with the user attribute ‘gender’, the processor may identify an associated set of stored touch parameters from the stored training data set associated with the user attribute ‘gender.’ The processor may also determine a set of stored touch parameters for each of the other sets of touch parameters (corresponding to other user attributes), in a similar manner.

In some embodiments, the processor may identify the associated set of stored touch parameters from among the plurality of stored touch parameters based on a predefined criterion of match between the determined set of touch parameters and the plurality of stored touch parameters. For each touch parameter in the determined set of touch parameters, the processor may look for a matching value of a corresponding stored touch parameter that satisfies the predefined criterion of match. The processor may search for such a matching value in the training data set associated with the same user attribute to which the determined set of touch parameters is associated. For example, if the determined set of touch parameters is associated with the user attribute ‘gender’, the processor may perform a search in the ‘gender’ training data set. The processor may first locate, for a touch parameter, a corresponding stored touch parameter. In keeping with the previous example, for a length of a touch stroke that is determined based on a touch input, the corresponding touch parameter is length that is stored in the ‘gender’ training data set. This stored parameter may have multiple sample values stored along with it. Here, the processor may look for a matching value of length from all the stored sample values of length in the ‘gender’ training data set.

In an exemplary scenario, for a length of touch stroke determined based on a touch input, the processor may look for a stored sample value of length of touch stroke based on the predefined criterion of match i.e., which sample value lies closest to the determined value of length. The sample value that lies closest to the determined value of length is considered as a matching value. This matching value may belong to either the sample values or the female sample values corresponding to the length of touch stroke. On identifying a matching value, the processor may also decide whether the value belongs to a male cluster or a female cluster depending on where the matching value—from the male sample values or the female sample values.

In further accordance with the above exemplary scenario, the value of the touch parameter ‘length’ determined based on a touch input may be 510 pixels. Here, the ‘male’ sample values may include multiple values of ‘length’ such as 400, 493, 498, 501, 502, 505, 512 pixels and so on and the female sample values may include values such as 450, 451, 454, 456, 459, and so on, but mostly non-overlapping with the male sample values. In this scenario, the processor may, according to a specified machine learning algorithm as specified, determine that a sample value: 512 lies closest to the determined value of length: 510 and belongs to the male cluster.

In another similar example, a value of pressure determined based on the touch input may be 150 units. The ‘male’ sample values may include values—140, 142, 147, 148, 149, 150, 151 units etc. and the ‘female’ sample values may include values—121, 122, 124, 125, and 127 etc. Here, the processor may identify the sample value ‘150 units’ as a matching value for pressure. In a similar manner, the processor may identify one matching value from the stored values for each of the touch parameters in the determined set of touch parameters. Each matching value may belong to either the ‘male’ sample values or the ‘female’ sample values. The processor may identify such matching values for all the touch parameters in the determined set of parameters. This process may be performed for all the other determined sets of touch parameters in a similar manner

The processor may, then, aggregate all the identified matching values to form the associated set of stored touch parameters. Each value in the associated set of stored parameters corresponds to a value in the set of touch parameters that was determined based on the touch input. The processor may form an associated set of parameters for each of the user attributes in a manner similar to that of the user attribute ‘gender’, as discussed in the previous example.

Once, a set of stored touch parameters associated with all the user attributes is determined, the processor may determine, for each such set of stored touch parameters, the associated user attribute, in step 108. This may include determining which user attribute is associated with a particular set of stored touch parameters that was identified in step 106. Determining the user attribute associated with a set of stored touch parameters may include a sequence of steps as illustrated in FIG. 1B and described as follows.

In step 110, the processor may obtain a set of stored touch parameters for the determined set of touch parameters. This set of stored touch parameters may include the set of stored touch parameters that is identified in step 106 of FIG. 1A. This set of stored touch parameters may include the aggregated matching values for all the touch parameters associated with a particular user attribute. For example, if the identified set of stored touch parameters corresponds to a set of touch parameters associated with the user attribute ‘gender’, the identified set of stored touch parameters may include matching values of stored parameters such as length: 501 pixels, maximum length of any segment: 90 pixels, minimum length of any segment: 40 pixels, average pressure: 150 units, and so on for all the touch parameters indicated in the column ‘gender’ in grouping table 1.

Further, in step 112, the processor may determine an intermediate value of the user attribute with respect to each stored touch parameter in the associated set of stored touch parameters. For example, an intermediate value of the user attribute ‘gender’ with respect to the first touch parameter: average pressure associated with touch stroke, may be ‘male.’ Further, an intermediate value of the user attribute with respect to a second touch parameter: maximum pressure in any segment may be ‘male.’ Similarly, an intermediate value of the user attribute ‘gender’ may be determined with respect to all the remaining touch parameters until the last touch parameter in the associated set of stored touch parameter.

The intermediate value of the user attribute with respect to a touch parameter may be determined based on the training data set from which the matching value for that touch parameter was selected. For example, the value of the user attribute ‘gender’ may be ‘male’ with respect to the touch parameter ‘length’ because the matching value of length: 512 pixels was selected from the ‘male’ cluster in the ‘gender’ training data set. Similarly, the value of the user attribute ‘gender’ may be ‘male’ with respect to a number of other touch parameters such as total length of a touch stroke, maximum length of any segment, minimum length of any segment, average pressure associated with the touch stroke, maximum pressure across any touch segment, minimum pressure across any touch segment, speed associated with the touch stroke, and average speed associated with the touch segments. This may be because the matching values for each of these parameters were selected from the ‘male’ cluster in the ‘gender’ training data set. However, for some of the other touch parameters such as total area covered by the touch stroke, direction of the touch stroke, maximum area of any segment, minimum area of any segment, and average length of touch segments, the matching values may have been selected from the ‘female’ cluster of the ‘gender’ training data set. Accordingly, the intermediate value of the user attribute ‘gender’ may be determined as ‘female’ with respect to these touch parameters.

On determining the intermediate values of the user attribute ‘gender’ with respect to all the touch parameters, the processor may determine whether any intermediate value has a maximum probability of occurrence among all the possible intermediate values, in step 114. This may include counting the number of touch parameters with respect to which each intermediate value is determined. In keeping with the previous example, the number of touch parameters for which the intermediate value ‘male’ is 8 and the number of touch parameters for which the intermediate value ‘female’ is 5. Thus, the probability of occurrence of the intermediate value ‘male’ is 8/13 and that for the intermediate value ‘female’ is 5/13. The processor may, similarly, determine intermediate values for all such identified sets of stored touch parameters.

If the result of decision in step 114 is yes, i.e., a an intermediate value having a maximum probability of occurrence is found, the processor may assign the intermediate value with the maximum probability of occurrence as a final value to the user attribute, in step 116. In keeping with the previous example, the intermediate value ‘male’ has more probability of occurrence than the probability of occurrence of the intermediate value ‘female’ because the instances of occurrence of the intermediate value ‘male’ is more than the instances of occurrence of the intermediate value ‘female.’ Therefore, the final value of the user attribute ‘gender’ is determined to be ‘male’ and is assigned to the user attribute ‘gender.’ The processor may then conclude that the touch stroke was entered by a male user based on the final value of the user attribute. The processor may make similar conclusions with respect to an age group, an emotion, an ethnicity, and/or a personality characteristic of the user. For example, the processor may determine that the user who entered the touch stroke is a ‘male’ in an age group above 50 years and exhibits the emotion ‘joy’ based on determining the final values of the user attributes ‘gender’, age group', and ‘emotion’, respectively. Similar conclusions may be made with respect to the user's ethnicity and/or personality characteristics also.

On the other hand, if the result of decision in step 114 is no, the processor may conclude that two or more intermediate values exist with equal probability of occurrence. In this scenario, the processor may apply a weighted algorithm to the intermediate values with equal probability, in step 118. In this step, if two or more intermediate values have equal probability of occurrence, preference may be given to the intermediate value having a higher priority according to a predetermined priority order decided by the manufacturer. In some embodiments, the manufacturer of the electronic device may have assigned a priority order to all the touch parameters based on a criticality of a touch parameter in determining a user attribute over another touch parameter. In some embodiments, this priority order may be indicated by the order in which touch parameters are listed in grouping table 1. In one example, average pressure applied may be more critical as a determining factor for a user attribute than the direction of a stroke. Thus, if the probability of occurrence of the average pressure applied is equal to that of the direction of the stroke, the processor may assign higher probability of occurrence to the average pressure applied over direction over the stroke. Once the weighted algorithm has been applied, the processor may determine a final value of the user attribute by determining whether any intermediate value has a maximum probability of occurrence, in step 114. On determining an intermediate value having the maximum probability of occurrence, the processor may then assign this intermediate value as the final value to the user attribute.

In keeping with the previous example, the final value of the user attribute ‘gender’ may be determined to be ‘male.’ In a similar manner, the processor may determine a final value for other user attributes: emotion, age group, ethnicity, and/or personality characteristic as discussed in the context of FIGS. 1A and 1B.

Referring back to FIG. 1A, in step 120, the processor may provide the final value of each user attribute once all the final values have been determined. This may include storing the final values of all the user attributes in the memory according to some embodiments. In some embodiments, however, the final values of one or more of the user attributes may be displayed to a user. Additionally in some embodiments, the final values of one or more user attributes may be provided by the electronic device to a third party such as a server associated with a media agency to enable the media agency to analyze the user attributes of various users and provide relevant media on their touch screen electronic devices.

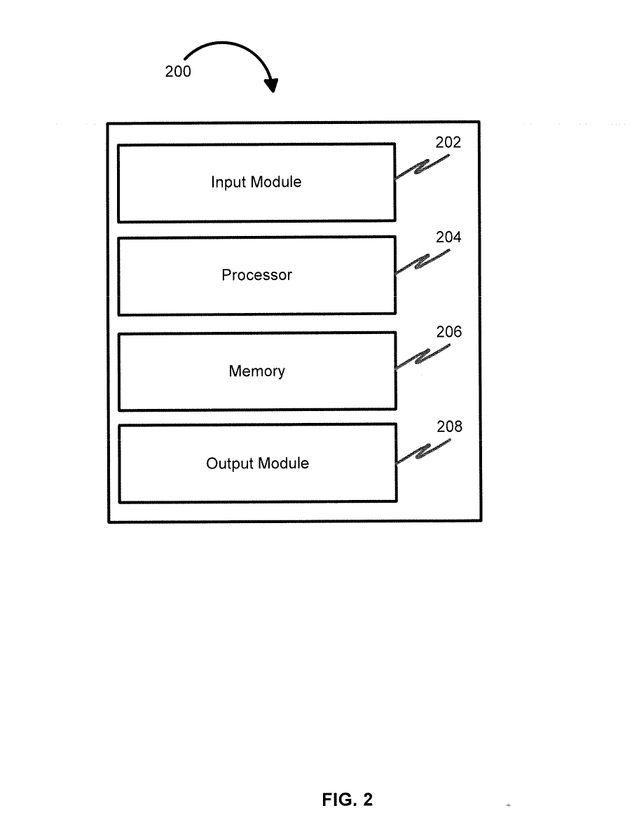

FIG. 2 illustrates an electronic device 200 for determining user attributes in accordance with some embodiments. Electronic device 200 may include an input module 202, a processor 204, a memory 206, and an output module 208. In some embodiments, electronic device 200 may include a touch screen mobile device such as a smartphone, a touch pad device, a tablet, a touch screen personal digital assistant, a touch screen laptop, or a touch screen television. It should be noted, however, that the electronic device is not limited to these devices and may include any computing device on which touch functionality may be implemented either as an internal functionality or by connecting external peripherals to the electronic device.

Memory 206 of electronic device 200 may include instructions that are executable by processor 204 to determine various user attributes associated with one or more users. Input module 202 of electronic device 200 may receive a touch input from a user of the electronic device. The input module may include hardware and/or software components that may include a touch based interface and/or a set of coded instructions for receiving a touch input from a user.

Once, the touch input is received, processor 204 may determine one or more sets of touch parameters based on the touch input, each set of touch parameters associated with a user attribute. On determining these one or more sets of parameters, processor 204 may identify, for each of the one or more sets of touch parameters, an associated set of stored touch parameters from among a plurality of stored touch parameters. The identification may be performed by processor 204 based on a predefined criterion of match between the set of touch parameters and the plurality of stored touch parameters. Further, processor 204 may determine, for each of the one or more sets of touch parameters, the associated user attribute based on the set of stored touch parameters associated with that set of touch parameters. On determining the user attribute associated with all the sets of touch parameter, processor 204 may provide these user attributes to output module 208. Output module 208 may include hardware and/or software components that may include a display screen and/or a set of instructions to display the values of the user attributes. In some embodiments, output module 208 may store the values of the determined user attributes in memory 206 of electronic device 200. In some embodiments, however, the values of the determined user attributes may be provided to a third party such as a media agency such that the media agency is able to provide relevant media based on these user attributes.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for determining user attributes, the method comprising:
receiving, by an attribute management computing device, a touch input;
determining, by the attribute management computing device, one or more sets of touch parameters based on the touch input, each set associated with a user attribute;
identifying, by the attribute management computing device, for each of the one or more sets of touch parameters, an associated set of stored touch parameters from among a plurality of stored touch parameters based on a predefined criterion of match between the set of touch parameters and the plurality of stored touch parameters;
determining, by the attribute management computing device, for each of the one or more sets of touch parameters, the associated user attribute based on the associated set of stored touch parameters; and
providing, by the attribute management computing device, the determined user attribute associated with each of the one or more sets of touch parameters.

2. The method of claim 1, wherein determining the one or more sets of touch parameters comprises:
determining, by the attribute management computing device, a plurality of touch parameters based on the touch input; and
grouping, by the attribute management computing device, the plurality of touch parameters into the one or more sets of touch parameters.

3. The method of claim 1, wherein identifying, for each of the one or more sets of touch parameters, an associated set of stored touch parameters comprises:
identifying, by the attribute management computing device, for each touch parameter in the set of touch parameters, a matching value of a corresponding stored touch parameter based on the predefined criterion of match between a value of the touch parameter and the matching value of the corresponding stored touch parameter; and
aggregating, by the attribute management computing device, the identified values to form the associated set of stored touch parameters.

4. The method of claim 3, wherein determining, for each of the one or more sets of touch parameters, the associated user attribute based on the associated set of stored touch parameters comprises:
determining, by the attribute management computing device, for each touch parameter in the set of touch parameters, an intermediate value of the associated user attribute based on the matching value of the corresponding stored touch parameter;
selecting, by the attribute management computing device, an intermediate value from the determined intermediate values based on a second predefined criterion; and
assigning, by the attribute management computing device, a final value to the associated user attribute based on the selected intermediate value.

5. The method of claim 4, wherein the second predefined criterion comprises determining that the probability of occurrence of an intermediate value has a highest value among the probability of occurrence among the determined intermediate values.

6. The method of claim 1, wherein the user attribute comprises one or more of an age group associated with a user, a gender associated with the user, an emotion associated with the user, an ethnicity associated with the user, or a personality characteristic associated with the user.

7. An attribute management computing device comprising:
a processor coupled to a memory and configured to execute programmed instructions stored in the memory, comprising:
receiving a touch input;
determining one or more sets of touch parameters based on the touch input, each set associated with a user attribute;
identifying, for each of the one or more sets of touch parameters, an associated set of stored touch parameters from among a plurality of stored touch parameters based on a predefined criterion of match;
determining, for each of the one or more sets of touch parameters, the associated user attribute based on the associated set of stored touch parameters; and
providing the determined user attribute associated with each of the one or more sets of touch parameters.

8. The device of claim 7, wherein the processor is further configured to execute programmed instructions stored in the memory further comprising:
determining a plurality of parameters based on the touch input; and
grouping the plurality of parameters into the one or more sets of touch parameters.

9. The device of claim 8, wherein identifying, for each of the one or more sets of touch parameters, an associated set of stored touch parameters further comprises:
identifying, for each touch parameter in the set of touch parameters, a matching value of a corresponding stored touch parameter based on the predefined criterion of match between a value of the touch parameter and a plurality of values of the corresponding stored touch parameter; and
aggregating the identified matching values to form the associated set of stored touch parameters.

10. The device of claim 9, wherein determining, for each of the one or more sets of touch parameters, the associated user attribute based on the associated set of stored touch parameters comprises:
determining, for each touch parameter in the set of touch parameters, an intermediate value of the associated user attribute based on the matching value of the corresponding stored touch parameter;
selecting an intermediate value from the determined intermediate values based on a second predefined criterion; and
assigning a final value to the associated user attribute based on the selected intermediate value.

11. The device of claim 10, wherein the second predefined criterion comprises determining that the probability of occurrence of an intermediate value has a highest value among the probability of occurrence among the determined intermediate values.

12. The device of claim 7, wherein the user attribute comprises one or more of an age group associated with a user, a gender associated with the user, an emotion associated with the user, an ethnicity associated with the user, or a personality characteristic associated with the user.

13. A non-transitory computer readable medium having stored thereon instructions for determining user attributes comprising machine executable code which when executed by a processor, causes the processor to perform steps comprising:
receiving a touch input;
determining one or more sets of touch parameters based on the touch input, each set associated with a user attribute;
identifying, for each of the one or more sets of touch parameters, an associated set of stored touch parameters from among a plurality of stored touch parameters based on a predefined criterion of match between the set of touch parameters and the plurality of stored touch parameters;
determining, for each of the one or more sets of touch parameters, the associated user attribute based on the associated set of stored touch parameters; and
providing the determined user attribute associated with each of the one or more sets of touch parameters.

14. The medium of claim 13, wherein determining the one or more sets of touch parameters comprises:
determining a plurality of touch parameters based on the touch input; and
grouping the plurality of touch parameters into the one or more sets of touch parameters.

15. The medium of claim 13, wherein identifying, for each of the one or more sets of touch parameters, an associated set of stored touch parameters comprises:
identifying, for each touch parameter in the set of touch parameters, a matching value of a corresponding stored touch parameter based on the predefined criterion of match between a value of the touch parameter and the matching value of the corresponding stored touch parameter; and
aggregating the identified values to form the associated set of stored touch parameters.

16. The medium of claim 15, wherein determining, for each of the one or more sets of touch parameters, the associated user attribute based on the associated set of stored touch parameters comprises:
determining, for each touch parameter in the set of touch parameters, an intermediate value of the associated user attribute based on the matching value of the corresponding stored touch parameter;
selecting an intermediate value from the determined intermediate values based on a second predefined criterion; and
assigning a final value to the associated user attribute based on the selected intermediate value.

17. The medium of claim 16, wherein the second predefined criterion comprises determining that the probability of occurrence of an intermediate value has a highest value among the probability of occurrence among the determined intermediate values.

18. The medium of claim 13, wherein the user attribute comprises an age group associated with a user, a gender associated with the user, an emotion associated with the user, an ethnicity associated with the user, and a personality characteristic associated with the user.
